(19) United States
(12) Patent Application Publication
(10) Pub. No.: US 2013/0021747 A1
(43) Pub. Date: Jan. 24, 2013

(54) ALL-IN-ONE COMPUTER

(71) Applicant: ZHI-BIN GUAN, Tu-Cheng (TW)

(72) Inventor: ZHI-BIN GUAN, Tu-Cheng (TW)

(73) Assignee: HON HAI PRECISION INDUSTRY CO., LTD., Tu-Cheng (TW)

(21) Appl. No.: 13/207,467

(22) Filed: Aug. 11, 2011

(30) Foreign Application Priority Data
Jul. 19, 2011 (TW) 100125539

(51) Int. Cl. G06F 1/20

(52) U.S. Cl. 361/679.47

(57) ABSTRACT

An all-in-one computer includes a display, a chassis mounted to the display, a support connected to the chassis, and a heat dissipation assembly. A number of electronic components are received in the chassis. The heat dissipation assembly includes a heat sink mounted to the support, a fan mounted to the support and aligned with the heat sink, and a number of heat pipes extending from the heat sink and attached to the electronic components.

### BACKGROUND

1. Technical Field

The present disclosure relates to an all-in-one computer.

2. Description of Related Art

An all-in-one computer includes a display and a chassis integrated with the display. Traditionally, the chassis is small to be conveniently integrated with the display. Therefore, the inner space of the chassis which accommodates a processor a storage device, and other necessary electronic components is limited, making inclusion and positioning of a heat sink and fan difficult. Additionally, the display being arranged at a side of the chassis negatively influences the air flowing through the chassis, thus, the heat in the chassis cannot be dissipated in a timely fashion which could shorten the service life of the computer.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIGS. 1 and 2 are isometric views of an exemplary embodiment of an all-in-one computer from different perspectives.

FIG. 3 shows an inner structure of the all-in-one computer of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

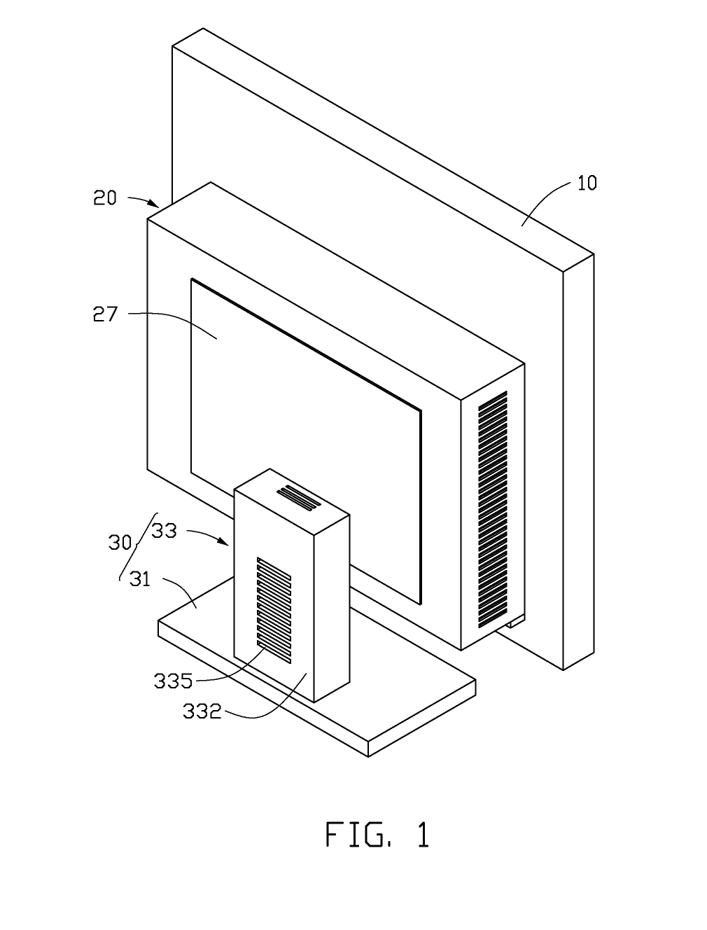

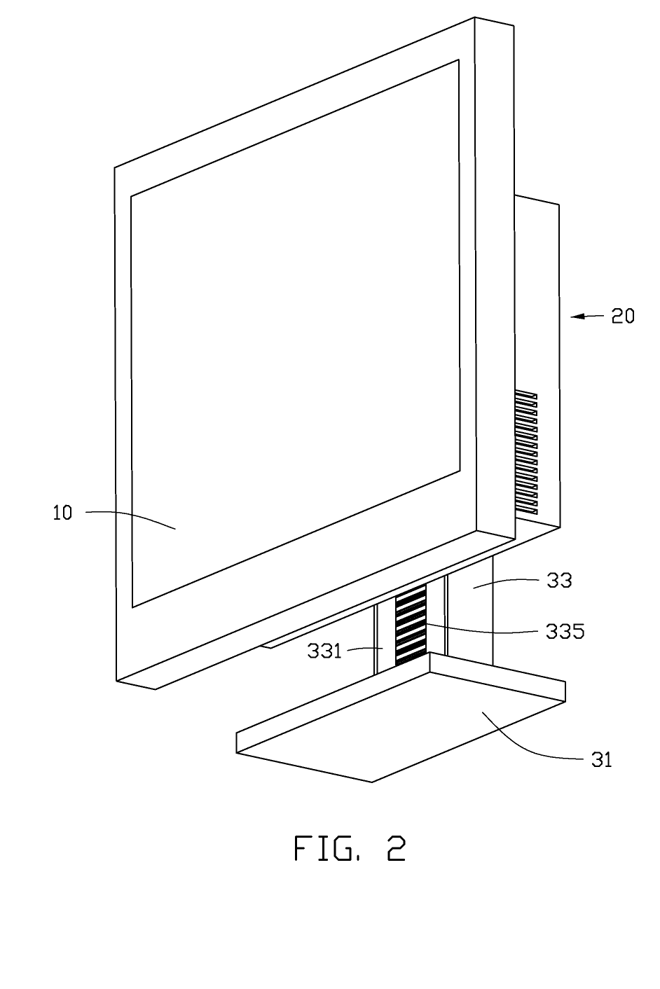

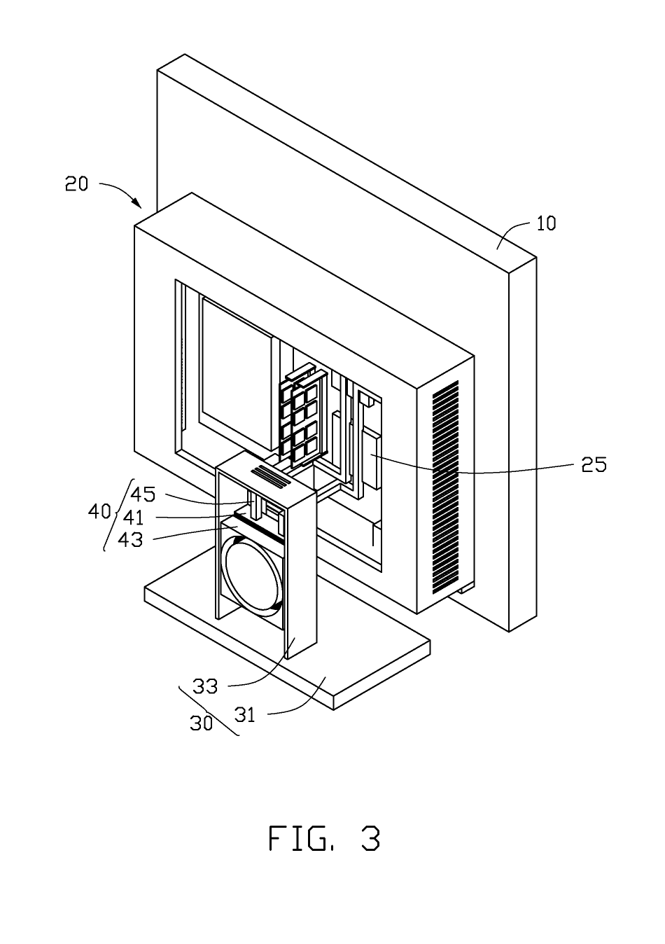

Referring to FIGS. 1-3, an exemplary embodiment of an all-in-one computer includes a display 10, a chassis 20 mounted to the display 10, a support 30, and a heat dissipation assembly 40. The chassis 20 is arranged at a rear side of the display 20.

The chassis 20 accommodates a plurality of electronic components 25. The chassis 20 includes a cover 27 covering a rear side of the chassis 20 opposite to the display 10.

The support 30 includes a bottom plate 31, and a connecting member 33 extends up from the bottom plate 31. The connecting member 33 is a rectangular shell, and includes opposite front wall 331 and rear wall 332 each defining a plurality of vents 335. An upper portion of the front wall 331 is fixed to the cover 27.

The heat dissipation assembly 40 includes a heat sink 41, a fan 43, and a plurality of heat pipes 45. The heat sink 41 and the fan 43 are received in the connecting member 33, and aligned with each other. The heat sink 41 is fixed to the connecting member 33, by common fixing means, such as screws. The fan 43 is fixed to the connecting member 33, or the heat sink 41, and aligned with the vents 335. Each of the heat pipes 45 extends through the front wall 331 of the connecting member 33 and the cover 27 of the chassis 20, with opposite ends of the heat pipe 45 attached to the electronic components 25 in the chassis 20, and the heat sink 41, respectively.

When the all-in-one computer operates, heat generated by the electronic components 25 is promptly conducted to the heat sink 41 through the heat pipes 45. The fan 43 produces airflow flowing towards the heat sink 41 to dissipate the heat accumulated on the heat sink 41 through the vents 335. Because the vents 335 are defined in the opposite front and rear walls 331 and 332, the airflow can be dissipated out of the connecting member 33 smoothly.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An all-in-one computer comprising:
a display;
a chassis mounted to the display, and accommodating a plurality of electronic components;
a support connected to chassis to support the chassis; and
a heat dissipation assembly comprising a heat sink mounted to the support, a fan mounted to support and aligned with the heat sink, and a plurality of heat pipes, opposite ends of each of the heat pipes attached to the electronic components, and the heat sink, respectively, to conduct the heat generated by the electronic components to the heat sink.

2. The all-in-one computer of claim 1, wherein the support comprises a bottom plate and a connecting member extending up from the bottom plate, an upper portion of the connecting member is fixed to the chassis, the connecting member is a shell receiving the heat sink and the fan.

3. The all-in-one computer of claim 2, wherein the connecting member defines vents in opposite front and rear walls of the connecting member, the fan is aligned with the vents.

4. The all-in-one computer of claim 3, wherein the front wall of the connecting member is fixed to a side of the chassis opposite to the display, the heat pipes extend through the front wall to be attached to the electronic components.
